(19) United States
(12) Patent Application Publication
(10) Pub. No.: US 2017/0239618 A1
(43) Pub. Date: Aug. 24, 2017

(54) A PROCESS FOR THE OXIDATION OF HYDROGEN SULFIDE TO SULFUR TRIOXIDE WITH SUBSEQUENT SULFUR REMOVAL AND A PLANT FOR CARRYING OUT THE PROCESS

(71) Applicant: HALDOR TOPSØE A/S, Kgs. Lyngby (DK)

(72) Inventors: Souheil Saadi, Rødovre (DK); Niklas Bengt Jakobsson, Kågeröd (SE)

(73) Assignee: Haldor Topsøe A/S, Kgs. Lyngby (DK)

(21) Appl. No.: 15/507,841

(22) PCT Filed: Sep. 9, 2015
(86) PCT No.: PCT/EP2015/070565

§ 371 Date: Mar. 1, 2017

(30) Foreign Application Priority Data
Sep. 16, 2014 (DK) PA 2014 00525

(51) Int. Cl. B01D 53/86; C01B 17/50; C01B 17/765; B01D 46/24; B01D 53/50

(52) U.S. Cl. CPC B01D 53/8612; B01D 46/2407; B01D 53/869; B01D 53/502; B01D 53/508; C01B 17/765; C01B 17/508; B01D 2255/20723; B01D 2255/20784; B01D 2255/20776; B01D 2255/1023; B01D 2255/20769; B01D 2255/2065; B01D 2255/2073; B01D 2255/20761; B01D 2255/904; B01D 2251/11; B01D 2251/404; B01D 2251/604

(57) ABSTRACT

A process for the oxidation of hydrogen sulfide to sulfur trioxide with subsequent sulfur trioxide removal comprises oxidizing hydrogen sulfide to sulfur trioxide in at least one catalyst-containing reactor and feeding the effluent from the last reactor to a candle filter unit for SO₃ removal, where it is mixed with an injected alkaline sorbent slurry or powder to form an alkali sulfate and a hot clean gas. Preferably the oxidation is done in two reactors, the first oxidizing H₂S to SO₂ over a monolith type catalyst and the second oxidizing SO₂ to SO₃ over a VK type catalyst.

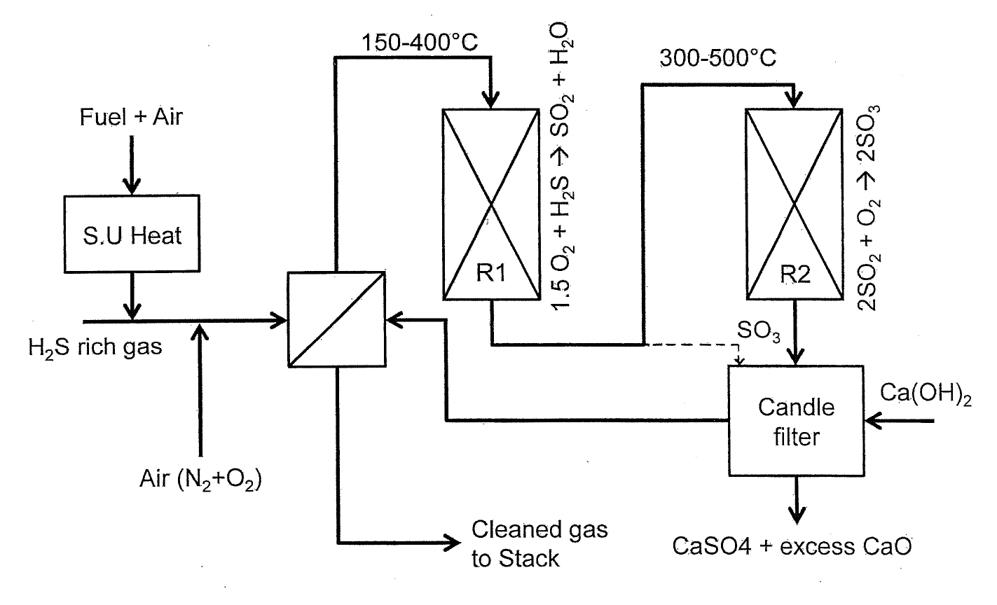

A process for the oxidation of hydrogen sulfide to sulfur trioxide with subsequent sulfur trioxide removal and a plant for carrying out the process

The present invention relates to a process for the oxidation of hydrogen sulfide (H₂S) to sulfur trioxide (SO₃) with subsequent sulfur trioxide removal and a plant for carrying out the process. More specifically, the subject of the invention is the oxidation of H₂S to sulfur dioxide (SO₂) and then to SO₃ by using known catalysts and subsequently recovering sulfur in a candle filter using an alkaline sorbent such as dry calcium hydroxide (Ca(OH)₂). The invention further relates to a plant for carrying out the process as well as a novel use of a monolithic type catalyst as a catalyst oxidizing hydrogen sulfide to sulfur dioxide.

The monolithic type catalyst is a corrugated fibrous monolith substrate coated with a supporting oxide. It is preferably coated with TiO₂ and subsequently impregnated with V₂O₅ and/or WO₃. The channel diameter of the corrugated monolith is between 1 and 8 mm, preferably around 2.7 mm. The wall thickness of the corrugated monolith is between 0.1 and 0.8 mm, preferably around 0.4 mm.

Usual routes to abatement of sulfur are solutions of absorbent type for low concentrations of H₂S, whereas higher concentrations of H₂S can be used for production of chemicals, e.g. elemental sulfur or sulfuric acid. For a variety of concentrations, thermal oxidation can also be used. The present invention can be seen as an alternative measure to reduce the chemical consumption cost with a minimal need for installed equipment, said measure especially being usable for H₂S levels between a few hundred ppm and a few percent.

The process of the invention can be summarized schematically as follows: A pre-heated H₂S-containing gas is mixed with air, and then the mixture enters a first catalyst-containing reactor via a heat exchanger. In this first reactor, H₂S is oxidized to sulfur dioxide (SO₂). The effluent from the first reactor is passed to a second catalyst-containing reactor, where the SO₂ is oxidized to SO₃. The SO₃-containing effluent is fed to a candle filter unit, into which for example Ca(OH)₂ is injected as a sorbent to remove SO₃.

The H₂S can also, on purpose, be oxidized directly to SO₃ in said first reactor by proper choice of oxidation catalyst and reaction conditions. In this case, the effluent from the first reactor is fed directly to the candle filter unit for removal of SO₃. As oxidation catalyst for direct oxidation to SO₃, a noble metal catalyst, such as a Pt/Pd catalyst, is used.

A candle filter is a batch-operated filter with candle-shaped filter elements arranged vertically inside a pressure vessel. The filter cake is formed on the outside of the filter candles, while the clear filtrate is discharged from the interior of the candles through dip pipes. Candle filters may be seen in process lines handling titanium dioxide, flue gas, brine clarification, china clay, fine chemicals and other applications that require efficient low moisture cake filtration or a high degree of polishing.

A candle filter is a dry scrubber. According to the invention, this specific dry scrubber is used instead of a wet caustic scrubber, which is often used in the techniques of the prior art. Wet scrubbers based on NaOH are for example used in the prior art to remove SO₂.

A dry scrubber system is described in US 2013/0294992, which concerns an air quality control system useful for processing a gas stream, such as a flue gas stream emitted from a fossil fuel fired boiler, for at least partial removal of acidic and other pollutants, such as SO₂, SO₃, HCl, HF, fly ash particulates and/or other acidic pollutants, therefrom.

US 2004/0109807 describes a method for removing SO₃ from flue gases, where a calcium hydroxide slurry is injected into the off-gases in the exhaust duct of an industrial plant, wherein sulfur-containing fuels are combusted. The calcium hydroxide slurry reacts with SO₃ produced as a result of the combustion process and forms a primary solid calcium sulfate reaction product. The industrial plant includes a wet scrubbing system which utilizes wet slaking of calcium oxide for the removal of sulfur oxides from off-gases.

Also U.S. Pat. No. 5,795,548 describes a dry scrubber-based flue gas desulfurization method and a plant for carrying out the method. A combined furnace limestone injection and dry scrubber flue gas desulfurization system collects solids from the flue gas stream in a first particulate collection device located downstream of an outlet of a convection pass of the furnace and upstream of the dry scrubber. The collected solids are diverted to the dry scrubber feed slurry preparation system to increase the efficiency of removal of the sulfur oxide species and also to increase the sorbent utilization. The level of lime in the feed slurry provided to the dry scrubber is thus increased, which enhances removal of sulfur oxide species in the dry scrubber. The decreased particulate loading to the dry scrubber helps to maintain a desired degree of free moisture in the flue gas stream entering the dry scrubber, which enhances removal of sulfur oxide species both in the dry scrubber and in the downstream particular collector.

From U.S. Pat. No. 4,764,355 a process for removing solid and gaseous noxious matter from hot gases is known. In said process, metal candle-type gap filters are used to remove particles from a hot gas stream containing sulfur oxides so that, in the filter cake which is built up upon the candle filters, the sorption reaction can continue as the hot gas stream passes through the filter.

Finally, DE 44 09 055 A1 describes a method for partial desulfurization of a hot gas, especially for a gas turbine, obtained from the burning of brown coal (lignite). This document mentions that a ceramic candle filter is used to desulfurize the SO₃-containing crude gas on the surface of the filter cake formed of fine lime and ashes, thereby forming CaSO₄. Then the filter cake is cleaned. This ensures that a new active surface is constantly formed on the filter cake by the crude gas containing fine ashes and fine particles of calcium carbonate, whereby the SO₃-component of the crude gas is bound to the filter cake through the formation of CaSO₄, and thus a pure gas is available.

The method according to the present invention differs from the prior art techniques in that a pre-heated gas containing H₂S is mixed with air, and the mixture is fed to a first catalyst-containing reactor via a heat exchanger. In this first reactor H₂S is oxidized to sulfur dioxide (SO₂) according to the reaction

1.5O₂+H₂S→SO₂+H₂O (1)

The catalyst in the first reactor is a monolith type catalyst as described earlier.

This catalyst can be manufactured from various ceramic materials used as a carrier, such as titanium oxide, and active catalytic components are usually either oxides of base metals (such as vanadium, molybdenum and tungsten), zeolites, or various precious metals. Catalysts of monolithic structure are known to provide favourable performance with respect to selectivity when the desired reaction is fast and the undesired reaction is slow. This is also the case in the present invention, where the conversion of H₂S to SO₂ is a fast reaction that benefits from the high surface area whereas the low load of active material per volume in a monolithic structure restricts the rate of the reaction converting SO₂ to SO₃.

It has surprisingly turned out that such catalysts are effective to promote the reaction (1) at the relatively low temperatures used in the process of the invention. Therefore, another aspect of the present invention is the use of a monolith type oxidation catalyst as described above to catalyse the reaction (1) at low temperatures.

Then the effluent from the first reactor is passed to a second catalyst-containing reactor, where the SO₂ is oxidized to SO₃ according to the reaction

2SO₂+O₂→2SO₃ (2)

The catalyst used in this reaction is selected among the applicant's VK catalysts, which are so-called supported liquid phase (SLP) catalysts. With SLP catalysts or a Pt-based catalyst, the oxidation of SO₂ takes place as a homogeneous reaction in a liquid film consisting of V₂O₅ dissolved in alkali-metal pyrosulfates on an inactive porous silica support made from diatomaceous earth.

Finally the SO₃ is fed to a candle filter unit, where an alkaline sorbent such as Ca(OH)₂ is injected to remove SO₃ and, if present, any residual SO₂. The solid discharge of sulfate, such as CaSO₄, can be mixed with water and re-injected in the system.

Thus, the present invention relates to a process for the oxidation of hydrogen sulfide to sulfur trioxide with subsequent sulfur trioxide removal, wherein hydrogen sulfide is oxidized to sulfur trioxide in at least one catalyst-containing reactor and wherein the effluent from the last reactor is fed to a candle filter unit for sulfur trioxide removal, where it is mixed with an injected slurry or powder of one or more alkaline sorbents to form an alkali sulfate and a hot clean gas.

More specifically, the present invention relates to a process for the oxidation of hydrogen sulfide to sulfur trioxide with subsequent sulfur trioxide removal, said process comprising the following steps:

(a) mixing a pre-heated gas rich in hydrogen sulfide with air and feeding the mixture to the inlet of a first oxidation reactor at a temperature of 150-400° C., where the hydrogen sulfide is oxidized to sulfur dioxide according to the above reaction (1),

(b) leading the effluent gas from the first oxidation reactor to the inlet of a second oxidation reactor at a temperature of 300-500° C., where the sulfur dioxide is oxidized to sulfur trioxide according to the above reaction (2), and (c) leading the sulfur trioxide-containing gas from the second oxidation reactor to a candle filter unit for sulfur trioxide removal, where it is mixed with an injected slurry or powder of one or more alkaline sorbents to form a sulfate and a hot clean gas,

wherein the first oxidation reactor contains a monolith type catalyst as described above, and the second oxidation reactor contains a supported liquid phase (SLP) catalyst, more specifically a VK catalyst.

A preferred alkaline sorbent to be injected into the candle filter unit is calcium hydroxide (Ca(OH)₂), but instead of calcium hydroxide, calcium carbonate may be used.

Other alkaline sorbents may be used as well. For example it is possible to use a magnesium-based sorbent, such as magnesium oxide or magnesium hydroxide, or a sodium-based sorbent, such as sodium carbonate.

Further it has turned out that certain sodium-based alkaline sorbents, such as sodium bicarbonate (NaHCO₃) and Trona (trisodium hydrogendicarbonate dihydrate, also known as sodium sesquicarbonate dihydrate; Na₃(CO₃)(HCO₂).2H₂O), are more reactive with SO₂ than calcium-based sorbents in the temperature range from 135 to 500° C.

In addition to using a single alkaline sorbent, it is also possible to use various combinations of alkaline sorbents.

The monolith type catalyst is preferably manufactured from a support material comprising one or more oxides of metals selected from aluminum, silicon and titanium, and the active catalytic components preferably comprise one or more oxides of a metal selected from vanadium, chromium, tungsten, molybdenum, cerium, niobium, manganese and copper. Said materials are effective in the catalytic oxidation of hydrogen sulfide at low temperatures.

The VK catalysts are specifically designed by the applicant to be used for converting SO₂ to SO₃ in any sulfuric acid plant. They are generally vanadium-based and may contain cesium as an additional catalyst promoter to enhance the action of the vanadium and activate the catalyst at a much lower temperature than conventional non-cesium catalysts. A major leap in activity has been obtained with VK catalysts containing a high fraction of vanadium in the active oxidation state V⁵⁺.

Monoliths are increasingly being used, developed, and evaluated as catalyst supports in many new reactor applications such as chemical and refining processes, catalytic combustion, ozone abatement etc. When the active catalyst has a monolithic structure, it displays a low pressure drop.

The present invention also relates to a plant for carrying out the process for the oxidation of hydrogen sulfide to sulfur trioxide. The plant, which is depicted on the appended figure, mainly consists of two oxidation reactors R1 and R2 for the above oxidation reactions (1) and (2), respectively, and a candle filter for removal of sulfur trioxide from the process gas. The plant further comprises a unit for pre-heating the H₂S-containing gas, and a heat exchanger. In the heat exchanger the gas is heated to a temperature of 150-400° C. before entering the first reactor R1. Following the reaction (1) in R1 the effluent gas is either fed to the reactor R2 at a temperature of 300-500° C. or fed directly to the candle filter unit (as shown by the dotted line in the figure). After the reaction (2) in R2 the resulting SO₃-containing gas is led to the candle filter unit, where an alkaline sorbent, for example Ca(OH)₂ as indicated in the figure, is injected to remove SO₃.

The SO₃ ends up as sulfate, in this case CaSO₄, in the filter cake, possibly together with an excess of CaO. The cleaned gas with a temperature around 400° C. is passed through the heat exchanger for heating up the feed gas, and it leaves the heat exchanger as a cleaned gas with a temperature around 100° C.

In the above plant design, all oxidation catalysts can fit into the reactors, and the dry scrubber, i.e. the candle filter, is replacing similar technologies where wet caustic scrubber systems are used. A major advantage in this respect is that the caustic chemicals cost will be reduced by approximately 70%, and a hot clean gas is produced, which can be used in the heat exchanger of the plant as mentioned above.

1. A process for the oxidation of hydrogen sulfide to sulfur trioxide with subsequent sulfur trioxide removal, said process comprising the following steps:
(a) mixing a pre-heated gas rich in hydrogen sulfide with air and feeding the mixture to the inlet of a first oxidation reactor at a temperature of 150-400° C., where the hydrogen sulfide is oxidized to sulfur dioxide according to the reaction
1.5O₂+H₂S→SO₂+H₂O (1),
(b) leading the effluent gas from the first oxidation reactor to the inlet of a second oxidation reactor at a temperature of 300-500° C., where the sulfur dioxide is oxidized to sulfur trioxide according to the reaction
2SO₂+O₂→2SO₃ (2),
and
(c) leading the sulfur trioxide-containing gas from the second oxidation reactor to a candle filter unit for sulfur trioxide removal, where it is mixed with an injected slurry or powder of one or more alkaline sorbents to form an alkali sulfate and a hot clean gas.

2. The process according to claim 1, wherein the first oxidation reactor contains a monolith type catalyst and the second oxidation reactor contains a supported liquid phase (SLP) catalyst.

3. The process according to claim 1, wherein the alkaline sorbent is a calcium-based sorbent, such as calcium hydroxide or calcium carbonate.

4. The process according to claim 1, wherein the alkaline sorbent is a sodium-based sorbent, such as sodium carbonate, sodium bicarbonate or sodium sesquicarbonate-dihydrate.

5. The process according to claim 1, wherein the alkaline sorbent is a magnesium-based sorbent, such as magnesium oxide or magnesium hydroxide.

6. The process according to claim 2, wherein the catalyst in the first oxidation reactor comprises one or more oxides of a metal selected from vanadium, chromium, tungsten, palladium, molybdenum, cerium, niobium, manganese and copper.

7. The process according to claim 2, where the supported liquid phase (SLP) catalyst in the second oxidation reactor is a VK type catalyst.

8. The process according to claim 7, wherein the catalyst in the second oxidation reactor is a vanadium-based monolithic catalyst.

9. The process according to claim 8, wherein the catalyst contains cesium as an additional catalyst promoter to enhance the catalytic activity of the vanadium.

10. A plant for carrying out the process according to claim 1, for the oxidation of hydrogen sulfide to sulfur trioxide and subsequent sulfur trioxide removal, said plant comprising
a unit for pre-heating a hydrogen sulfide containing gas,
a heat exchanger,
a first oxidation reactor R1, wherein the hydrogen sulfide is oxidized to sulfur dioxide according to the reaction,
a second oxidation reactor R2, wherein sulfur dioxide is oxidized to sulfur trioxide according to the reaction, and
a candle filter unit, into which an alkaline sorbent such as calcium hydroxide is injected to remove sulfur trioxide, leaving a clean hot gas.

11. The plant according to claim 10, wherein the clean hot gas is fed to the heat exchanger to heat up the pre-heated mixture of air and a hydrogen sulfide-containing gas.

12. Use of a monolith type catalyst to catalyse the reaction (1) recited in claim 1.

13. Use according to claim 12, where the monolith type reactor is a corrugated fibrous monolith substrate coated with a supporting oxide and subsequently impregnated with V₂O₅ and/or WO₃.

14. Use according to claim 13, where the supporting oxide is TiO₂.
